(19) United States
(12) Patent Application Publication
(10) Pub. No.: US 2014/0108143 A1
(43) Pub. Date: Apr. 17, 2014

(54) SOCIAL CONTENT DISTRIBUTION NETWORK

(71) Applicant: Solariat Inc., Danville, CA (US)

(72) Inventors: Jeffrey Eric Davitz, Danville, CA (US); Conor McGann, San Carlos, CA (US)

(21) Appl. No.: 14/135,133

(22) Filed: Dec. 19, 2013

Related U.S. Application Data
(63) Continuation-in-part of application No. 14/032,893, filed on Sep. 20, 2013.
Application No. 14/032,893 is a continuation-in-part of application No. 13/598,261, filed on Aug. 29, 2012.
Application No. 13/598,261 is a continuation of application No. 13/040,092, filed on Mar. 3, 2011, now Pat. No. 8,271,583.
Application No. 13/040,092 is a continuation of application No. 12/851,489, filed on Aug. 5, 2010, now Pat. No. 7,921,156.
(60) Provisional application No. 61/703,599, filed on Sep. 20, 2012.

(51) Int. Cl. G06Q 30/02; G06Q 50/00

(52) U.S. Cl. CPC G06Q 30/0255; G06Q 30/0275; G06Q 50/01; G06Q 30/0277
USPC 705/14.53

(57) ABSTRACT

A social content distribution network (SCDN) allows content producers to search over content sponsors to learn about demand in content sponsor sub-networks. Audience tracking tools are provided for the content sponsor to learn about demand for content within different audiences (content consumers) in any of the content destinations and within different audiences in any of the content destinations. Content sponsors are also provided facilities to search over an index of content producers to find relevant content to push. Having discovered content the sponsor wishes to push into a particular audience, the sponsor may use the SCDN platform to create a payload that includes a link to the selected content and a creative that annotates the link, deliver this payload, and track its performance in the content destination.

### RELATED APPLICATIONS

This application is a CONTINUATION-IN-PART of U.S. application Ser. No. 14/032,893, filed Sep. 20, 2013, incorporated herein by reference in its entirety, which application is a (i) a NONPROVISIONAL of and claims priority to U.S. Provisional Application No. 61/703,599, filed Sep. 20, 2012, which is incorporated herein by reference in its entirety, and (ii) a CONTINUATION-IN-PART of and claims priority to U.S. patent application Ser. No. 13/598,261, filed Aug. 29, 2012, which is a CONTINUATION of U.S. patent application Ser. No. 13/040,092, filed Mar. 3, 2011, now U.S. Pat. No. 8,271,583, which is a CONTINUATION of U.S. patent application Ser. No. 12/851,489, filed Aug. 5, 2010, now U.S. Pat. No. 7,921,156.

### FIELD OF THE INVENTION

The present invention relates to systems and methods for coordinating the production and delivery of content to social network audiences (e.g., subscribers to a social network news feed, blog, Twitter™ stream, etc.).

### BACKGROUND

Advertisers seeking to use the potential power of Web-based social network sites, as it concerns access to potential consumers of goods and services, have developed models for capitalizing on the insertion of advertisements into conversations facilitated through those sites. Such advertisements came in various forms, including banner ads, which appear across portions of a web page, and sponsored links, which typically appear in designated sections of search result pages. Many Web users find such advertisements to be annoying in that they are often placed in locations of a web page that interrupt the user's reading or interaction with content on the page, are contextually irrelevant, and/or are otherwise disruptive of the web browsing experience. The situation is compounded when dealing with websites featuring user-generated content (UGC) because contributors to such sites often have a low tolerance for advertisements on the sites that are perceived as not relevant to the content. At the same time, advertising is one of the primary ways in which website operators offset the cost of producing content and otherwise maintaining websites.

### SUMMARY OF THE INVENTION

A social content distribution network (SCDN) configured in accordance with various embodiments of the present invention allows content producers to search over content sponsors to learn about demand in content sponsor sub-networks. Audience tracking tools are provided for the content sponsor to learn about demand for content within different audiences (content consumers) in any of the content destinations and within different audiences in any of the content destinations. Content sponsors are also provided facilities to search over an index of content producers to find relevant content to push. Having discovered content the sponsor wishes to push into a particular audience, the sponsor may use the SCDN platform to create a payload that includes a link to the selected content and a creative that annotates the link, deliver this payload, and track its performance in the content destination.

These and other embodiments of the invention are described in greater detail below, with reference to the accompanying figures.

### BRIEF DESCRIPTION OF THE DRAWINGS

The present invention is illustrated by way of example, and not limitation, in the figures of the accompanying drawings, in which:

FIG. 1 illustrates components of a network in which embodiments of the present invention may be implemented;

FIG. 2 illustrates an example of a process for determining creatives for insertion within a conversation in accordance with embodiments of the present invention;

FIG. 3 illustrates an example of a process for determining intention topics of utterances in accordance with embodiments of the present invention;

FIG. 4 illustrates an example of a creative for insertion in a conversation hosted at a takeoff page in accordance with embodiments of the present invention;

FIG. 5A illustrates a components of a computer system in which computer readable instructions instantiating the methods of the present invention may be stored and executed; and

FIG. 5B illustrates a software architecture for various ones of the computer systems illustrated in FIG. 1.

FIG. 6 illustrates an example of a process for selecting a content sponsor as part of a competitive process.

FIG. 7 illustrates an example of a process for selecting a content provider as part of a competitive process.

### DETAILED DESCRIPTION

We refer to a system that coordinates the production and delivery of content to social network audiences as a social content distribution network (SCDN). The SCDN may be visualized as a tripartite construct that includes (i) a set of content producers (e.g., publishers, bloggers, etc.), (ii) a set of content sponsors (e.g., brand owners/advertisers), and (iii) a set of content destinations (e.g., social networks or, more specifically, the subscribers or members thereof as reached through the social network media). In various embodiments, the present invention facilitates the delivery of content produced by the content producers under the auspices of the content sponsors to the content destinations as a means of promoting brand loyalty or other favorable relationship attributes with and among content consumers (e.g., the members of the social networks or other content destinations that read or otherwise experience the content delivered by the SCDN) and the content sponsors. The platforms that facilitate this delivery of content may be centralized or distributed and may be under the control of content sponsors themselves or a third party acting at the request of the content sponsors. That is, both enterprise and hosted service models are envisioned as instantiations of the present invention.

Content sources produce content over many topics. Content sponsors seek to use that content for their various purposes (e.g., content marketing) by delivering that content into content destinations. Consider the following example from the fashion industry. Content producers in this industry may include bloggers, consumers (e.g., providing Twitter and/or Facebook™ posts, photo streams, etc.), and others. A content sponsor (e.g., a fashion label, designer, department store or other retailer, etc.) may be interested in exploiting this content for a variety of purposes. The present SCDN allows the content sponsor to both find relevant (and, presumably, valuable) content and deliver that content (e.g., in the form of a referral link) into a social network like Twitter (e.g., perhaps to followers of the content sponsor). The content may or may not be directly promotional of the content sponsor—indeed, often it will not be. Instead, the content may simply be known to be of interest to the content sponsor's followers and the content sponsor may facilitate the delivery of the content to its followers as a “service”. This has the effect of promoting good will among the followers and perhaps enhancing the reputation of the content sponsor. Of course, in arranging for delivery of the content, content sponsors may include or insert promotional items, or may include those promotional items on landing pages at which the content is provided and to which the content consumers are directed. The SCDN may include many members in each sub-network of the full tripartite graph. That is, there may be many content producers, many content sponsors and many content destinations. Interestingly, however, large membership(s) are not necessarily required in order for positive network effects to be derived. For example, positive network effects may be realized if only a single content destination exists.

Whether instantiated as an enterprise application or a hosted service, the SCDN includes a server or other computer system that acts as a coordination node for the various activities described herein. Also included are one or more databases, which are communicatively coupled and available to the server. The database(s) store searchable indexes for the set of content producers and content sponsors, and a list of content destinations. The indexes can be enhanced by various kinds of metadata, such as from third party classifications and annotations. In addition, content sponsors may be provided tools and privileges to annotate their entries with information the respective sponsors consider to be of potential interest to the content sources. For example, content sponsors could provide a set of topics that they are interested in sponsoring, including bid prices for topics shared across multiple sponsors.

In operation, the present SCDN allows content producers to search over content sponsors, e.g., by topic and/or other keywords, to learn about demand in the content sponsor sub-network. Audience tracking tools are provided for the content sponsor to learn about demand for content within different audiences (content consumers) in any of the content destinations. Content sponsors can likewise use the audience tracking tools to learn about demand for content within different audiences in any of the content destinations. Content sponsors are also provided facilities to search over the index of content producers, e.g., by topic and/or other keywords, to find relevant content to push. Having discovered content the sponsor wishes to push into a particular audience, the sponsor may use the SCDN platform to create a payload, which includes a link to the selected content and a creative that annotates the link. The SCDN platform allows the content sponsor to deliver this payload and to track its performance in the content destination (e.g., track clicks, etc.). Content destinations are thus passive elements of the SCDN, receiving the payload and thereby facilitating a mechanism for the content consumers to discover and act on it.

Content producers may be permitted join the SCDN for nominal charge (or no charge) but usually will be required to register with the system. For example, content providers will need to specify a web address (e.g., a URL) at which their content can be found and perhaps some basic profile information. Content producers may provide brand-specific messaging for content consumers at landing pages to which the content sponsors direct the content consumers, but this is not necessarily so. In some embodiments, content can be sourced without collaboration from the content producers, provided that content is in the public domain.

To participate in the SCDN, content sponsors may be required to pay a fee (e.g., a membership fee). Alternatively, membership may be provided free of charge, but per-use fees assessed when a content sponsor bids on or wins the right to distribute content the sponsor desires to push to its audience of interest. For example, a content sponsor may be assessed a fee when the sponsor uses particular content and/or when the content is acted on in the content destination (indicated, for example, by a click). Revenue generated from the content producers may be split between the SCDN provider and the content producer(s).

For content producers, the SCDN provides social search engine optimization (SEO) for their content. It is well known that social signals influence search engine rankings of content. The SCDN provides means by which content can be effectively pushed into social media in a way that improves social signaling. In addition, content producers are rewarded financially for sharing their valuable content while still maintaining a degree of independence from any particular brand sponsorship. The SCDN allows a content producer's content to be sponsored (paid for) by a large number of potential sponsors

For the content sponsor, the SCDN provides access to a distributed workforce for content marketing and a means of accessing social networks. Retailers and others have have found it difficult to market into social networks using traditional vectors. The present SCDN provides a mechanism for scaling what social network audiences do find acceptable, namely distributing endorsed links.

By permitting the form of endorsed links contemplated herein, content destinations increase the value of their members, leading to enhanced opportunities for advertising and, potentially, membership charges. That is, the content sponsors will find more value in having an active presence in the content destination.

The present inventors recognize that all network-based businesses have difficulty with the cold start problem. That is, trying to define a value to the early members of the network. This problem is very addressable in the context of the SCDN. The SCDN platform provides value as a means for an individual content sponsor or producer to identify and respond to demand in content destinations (social networks). That is, the tools are useful/valuable completely independent of the network. The network amplifies the value for the content producers by giving them access to sponsors and for the content sponsors by giving them access to a broader range of distributable content. The key point, however, is that each network participant is already engaged in their respective activities, and the SCDN supports those activities separately from the additional value provided by the network effect. Moreover, existing publicly available content may be used by content sponsors, in some instances without need for content producer cooperation. This too can help alleviate the cold start problem. Of course, content producers benefit by having their existing content optimized for social search, while content sponsors can gain immediate engagement by content consumers. The SCDN platform can allow implicit searches as content arrives to suggest matches.

Once content is placed into a content destination, typically a social network, it can be tracked. For example, systems configured in accordance with embodiments of the invention may track selections of and/or any re-transmissions of (e.g., retweets) the content in the social network or other content destinations. This information can be used to adjust pricing of content from the producer or in other related scores such as quality measures for that content producer. Such scores, or even the raw data, may be exposed to the content sponsors in order to inform their bids.

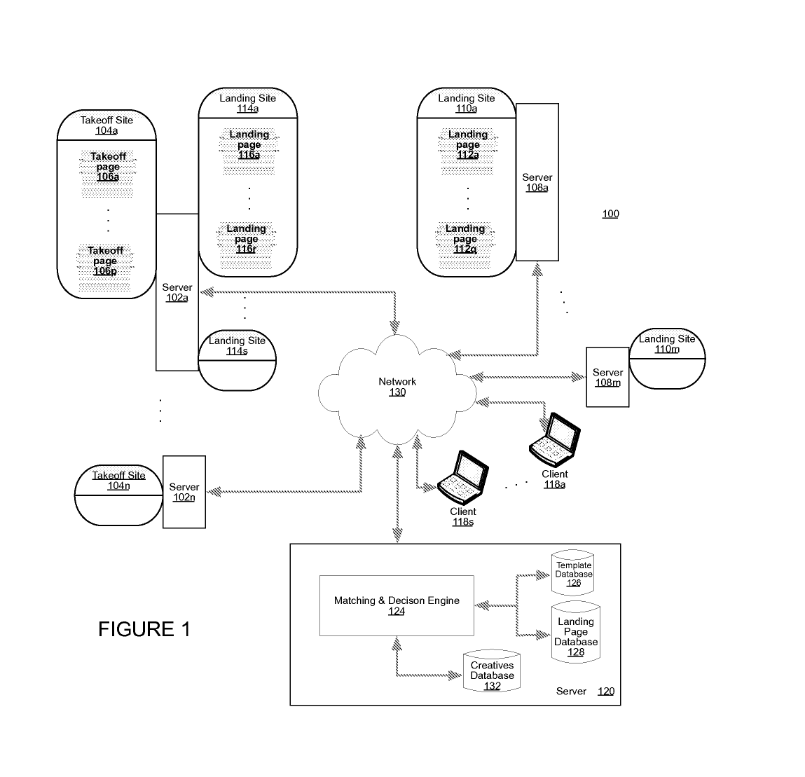

Having discussed the broad parameters of the SCDN, we turn now to some specifics of the underlying platform. In embodiments of the present invention, endorsed hyperlinks (“links”) or other direction-aiding materials are inserted into content destinations (e.g., Twitter tweets, social network commentary, e-mail threads, forum-hosted discussion boards, Facebook walls, etc.) at the direction of the content sponsors. The endorsed links point to other material (e.g., the content producers' content) that audience members (e.g., readers of the blogs, Twitter followers, etc.) might find helpful and/or relevant to their interests. The paradigm is thus one of a helpful service, rather than a mere mechanism for inserting advertising. To better understand the environment within which the present methods and systems operate, consider the network 100 illustrated in FIG. 1.

Included in network 100 are various servers 102a-102n, each hosting one or more takeoff sites 104a-104n. Each takeoff site 104 may include one or more takeoff pages 106a-106p. The takeoff sites may be social media or similar content destinations.

Also part of network 100 are a number of servers 108a-108m, hosting landing sites 110a-110m, any or each of which may be made up of a plurality of landing pages 112a-112q. The landing sites/pages may be the repositories of the various content producers' content. Notice that a server 102 hosting a takeoff site 104 with one or more takeoff pages 106 may also host one or more landing sites 114a-114s, any or each of which may include one or more landing pages 116a-116r. That is, any server may host any combination of takeoff and/or landing sites. When we refer to content on a takeoff site or landing site, we mean to include content that is located on a particular takeoff page of a takeoff site or landing page of a landing site, as appropriate.

The takeoff and landing sites are accessed by users via client systems 118a-118s. The client systems may, in some cases, be computer systems, such as personal computers or the like, but more generally may be any computer-based or processor-based device that executes application software which allows the content of the takeoff/landing site to be rendered for display to the user on a display device. For example, client systems may include computer systems, mobile devices such as iPads™, smart phones, mobile phones, etc., and the application software may be web browser software such as Microsoft Corporation's Internet Explorer™, Apple Inc.'s Safari™, or Google Inc.'s Chrome™, or instant messaging software such as Apple Inc.'s iChat™, America Online Inc.'s AIM™, etc. In some instances, dedicated applications (or “apps”) running on mobile computing platforms (such as tablet computers, smart phones, etc.) may be employed. Such apps often provide improved user experiences in the context of associated web sites and portals than those afforded through the use of web browser applications as they make use of dedicated application programming interfaces (APIs) for the associated websites. Any or all of the above-described applications are typically stored in one or more computer readable storage devices accessible to one or more processors of the subject client system and, when executed, cause the processor(s) to perform the operations necessary to render the subject sites/pages for display at the subject system (e.g., via a display device communicatively coupled to the processor). The various constituents of network 100 are communicatively coupled to one another via one or more computer/data networks 130, which may include the Internet and other networks coupled thereto. The precise nature of network 130 is not critical to the present invention.

Network 100 also includes server 120, which hosts a matching and decision engine 124. The matching and decision engine implements an embodiment of the present invention, however, in other embodiments the function of this engine may be instantiated in multiple distributed entities. Accordingly, the embodiment illustrated in FIG. 1 should be regarded as merely a convenient example for purposes of the following discussion and not as a limitation of the present invention.

Matching and decision engine 124 is configured to allow the content sponsors to both find relevant (and, presumably, valuable) content at one or more landing sites and deliver that content (e.g., in the form of a referral link) into a takeoff site/page. In addition, the matching and decision engine is configured to recognize any actionable user intention (with respect to a product or service, for example) expressed within content destinations or other on-line facilities. That determination of user intention may then trigger one or more actions, including bringing the landing page content to the attention of others (e.g., other users, an advertiser or the advertiser's proxy, or combinations thereof), by distributing the content to the content destination via an endorsed link or other means.

In one example, the actionable intention may be the recognition of a need of the user, e.g., a need for a particular product or service, or perhaps a need for information concerning a particular subject. In other instances, it may simply be a recognized interest of one or more users. The matching and decision engine 124 may determine a set (and here a set may be one or more) of candidate creatives to present to the user(s) by way of insertion into the takeoff site or other content destination. These creatives may serve as attractive lures, inducing the user and/or others (e.g., users associated with client systems 118a-118s) to explore (e.g., via selection of hyperlinks included in the creatives) material present on one or more of the landing site(s) that is relevant to a conversation on the takeoff site or, more generally, to interests of the users. In some cases the creatives, including their associated links to the landing sites, may be or include advertisements (“ads”), but other forms of creatives may also be used. In some instances, the selection of the one or more creatives to present within the conversation may be an entirely automated process, while in other cases human editors may filter a group of creatives proposed by the matching and decision engine 124 to select one or more creatives deemed well suited for presentation in the content destination.

Creatives may be fashioned using templates and, in one embodiment of the invention, a library of templates is stored in and obtained from a templates database 126, which is communicatively coupled to the matching and decision engine. This templates database may be hosted at the same or a different server than the matching and decision engine. A separate (or common) database 128 of landing page URLs is also maintained (either at server 120 or another server) and is likewise communicatively coupled and accessible to the matching and decision engine 124. Candidate landing pages may be obtained by receiving a content feed, making an API call or performing a crawl of one or more landing sites and the candidate creatives may be generated either by hand or by a set of heuristics based on textual analysis of the respective landing sites.

Matching and decision engine 124 may be configured to provide not just a single “best” matching creative for a particular recognized interest. Instead, in some cases, the matching and decision engine may be configured to provide a number of candidate creatives deemed relevant. Thus the matching and decision engine may deliver one or more creatives assessed to be the most suitable from an available pool of creatives (including, in some cases, creatives that are established or created in real time). In some cases, no creative will be delivered, for example where the matching and decision engine fails to identify a truly actionable intention or where an actionable intention is identified but is deemed not to be suitable for response by way of delivering a creative. These assessments may involve determining an intention type and topic (e.g., to at least a predetermined confidence level), evaluating the actionability of the intention topic and selecting one or more creatives for presentation (and/or deciding not to present a creative), for example on the basis of relevance scores of the creatives computed with respect to the determined intention type and topic.

Content consumer interests may be identified in any number of ways. In one instance, interests may be identified from personal profiles of the content consumers. These may be profiles that are maintained by the individual consumers at social network sites, etc., or maintained by these consumers at a site associated with the SCDN. Alternatively, or in addition, content consumer interests may be determined in an automated manner through the analysis of content consumer postings and identification of actionable intentions expressed therein.

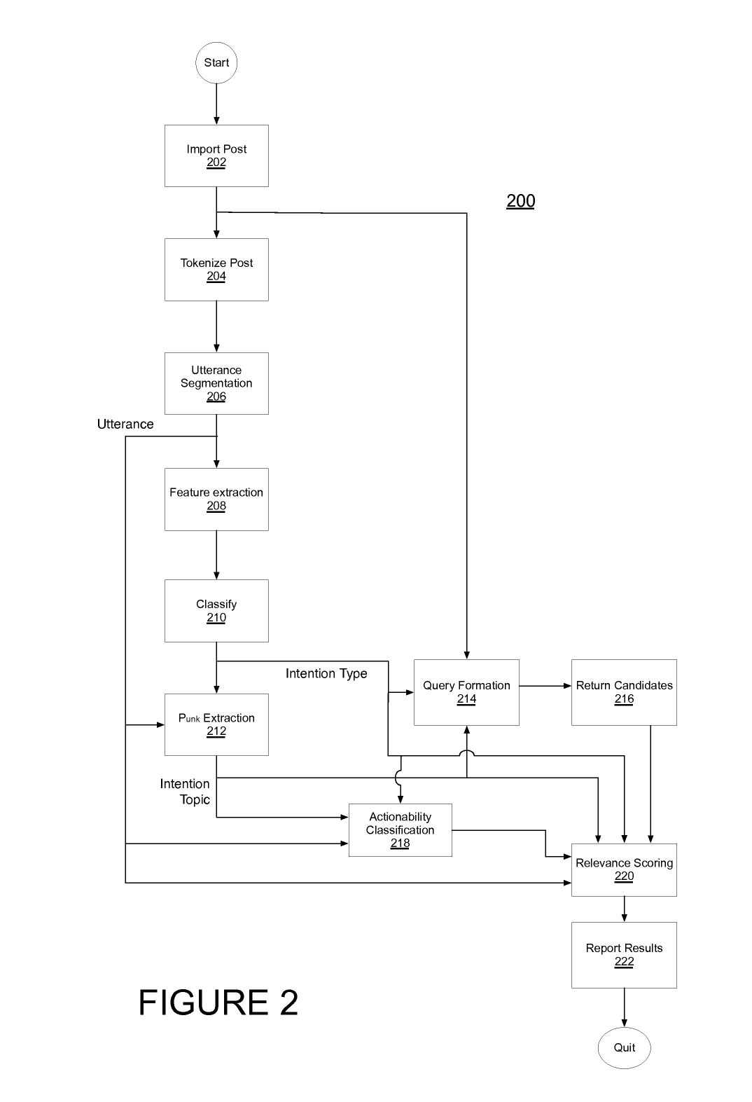

FIG. 2 illustrates aspects of an assessment process 200 for determining an actionable intention from a content consumer positing and selecting one or more creatives in response thereto. Note that this illustration is intended only as one example of an implementation of the present invention and should not be viewed as the sole means for same. In other embodiments, steps in process 200 may be performed in parallel and/or in different sequences for matters of convenience or to take advantage of distributed or increased processing capacity and resources. Further, selecting and delivering creatives is but one form of action that can be performed in response to determining an actionable intention in a content consumer positing.

Process 200 begins with a post being received 202 at, or harvested by, server 120. By “post” we mean any form of user generated content (UGC), including but not limited to, posts or updates to a social media site (whether as part of a multi-participant conversation or otherwise), tweets, postings on blogs, forums, and the like, comments made at third party web sites, etc. The posts may be received and/or harvested in real time and/or in accordance with a schedule determined by an operator of server 120 and/or customers of such operator.

Once obtained, the post is tokenized 204. Tokenizing breaks the string of text that makes up the post into words, phrases, symbols, or other meaningful elements (tokens). This can be regarded as segregating the post into “words”; however, the term words should be read broadly and is not intended to indicate that all tokens are actually equivalent to the familiar linguistic units commonly understood as words.

Once tokenized, the post is subjected to utterance segmentation 206. In this step, the various phrases in a post are divided up into discrete utterances (also known as speech acts). For example, a post such as:
“My dog won best in show today! He beat out several others. I must remember to stop at the store and pick up his favorite dog food as a reward.”
   may be divided into several utterances, as follows:
“My dog won best in show today!”
“He beat out several others.”
“I must remember to stop at the store and pick up his favorite dog food as a reward.”

In one embodiment, utterances are determined and segmented based upon the presence of punctuation marks commonly employed with sentence construction (e.g., periods, question marks, exclamation points, etc.). In other examples, single sentences may be segmented into more than one utterance (e.g., based on the presence of one or more demarcation features). Utterances may include questions, assertions, complaints, requests for action, and so on.

Utterance segmentation is not mandatory, but it is preferred. Some posts may contain multiple different thoughts, expressions, etc., and so trying to determine an appropriate set of one or more creatives for response can be difficult unless the post is segmented into utterances. By segmenting a post into utterances, better overall results (in terms of the quality of the creative(s) delivered to the user making the post) can be achieved.

Once the post has been segmented into utterances (if such segmentation is employed), feature extraction 208 can take place. Feature extraction may be accomplished using machine learning, heuristics or other techniques to represent the utterance in vector form. In one example, we use a bag of words representation model whereby each position in the vector is associated with a word token and the value at a given position in the vector represents the importance of the associated token within the utterance. Importance can be measured in several different ways, including, but not limited to:
term frequency (tf): e.g., the number of times that the word token appears in the utterance; or
tf-idf: term frequency multiplied by the inverse document frequency (i.e., the inverse of the rate of occurrence of the term across all documents in the corpus at hand, e.g., the subject UGC).

When generating the vector representation of a given utterance, a service provider may choose to weight word tokens within a post title more strongly than words that occur in the post body. It is also often advisable to use normalized vectors when generating similarity scores between vectors.

The output of the feature extraction process is a feature vector, which is applied as an input to a classifier 210. The classifier examines the feature vector to produce an intention type according to various rule sets. Intention types (which are determined on a per-utterance basis) may include questions, needs, problems, likes/dislikes, check-ins, etc.

Once the intention type information is determined, the utterance undergoes Pᵤₙₖ extraction 212 to determine intention topics. Pᵤₙₖ is a shorthand expression for a measure of confidence that the extracted topic is the actual topic of interest, for example a key noun phrase. Pᵤₙₖ extraction is a linguistics-based approach (rather than a pure keyword matching with sliding window technique) to identifying key noun phrases in the utterances. These key noun phrases are deemed to be the topic of the intention expressed in the utterance. For example, in the utterance, “I want stickers for my laptop”, the specified intention (or intention type) is an expression of desire (want), and the topic of that expressed desire is stickers (not a laptop). A keyword-based approach may have difficulty distinguishing between the stickers or the laptop as the true intention topic of the utterance. By relying on a linguistics-based approach rather than a mere keyword-based approach, however, the present method ensures that the true intention topic (stickers) is correctly identified more often than not.

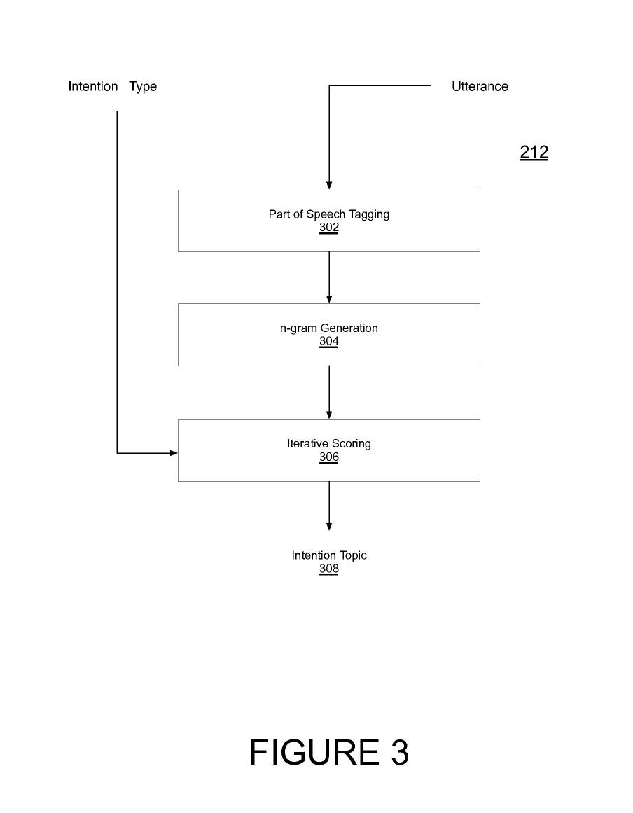

The Pᵤₙₖ extraction process 212 is discussed in greater detail with reference to FIG. 3. The utterance is provided to a tagging process 302 in which parts of speech elements in the utterance are tagged. The tagged utterance is then analyzed for n-grams 304. This involves using the identified noun phrases as anchor points and generating the n-grams around the noun phrases. The n-grams may be uni-grams, bi-grams, tri-grams or more complex structures. Generally, longer n-grams provide better results than shorter n-grams. The n-gram generation is performed independent of any influence by intention type and is a purely linguistic analysis. The result of the n-gram generation is a list of possible intention topics. These possible topics are then scored, according to intention type, in an iterative process 306, the output of which is that one of the possible intention topics is deemed to be the most likely intention topic 308 for the subject utterance.

Using n-grams, as opposed to simply using uni-grams, expands the list of possible intention topics from that which it might otherwise include. For example, in the utterance, “I want a laptop bag”, if only uni-grams were considered then the possible intention topics might be “laptop” or “bag”. If actions (such as the delivery of advertisements concerning either a laptop or a bag, but not specifically a bag for a laptop) were returned in response to this utterance, it is highly likely the actions would lead to unsatisfactory outcomes or be meaningless (e.g., the advertisements likely would be ignored because they would not be relevant to the true intention topic, the “laptop bag”).

The scoring procedure may start with heuristics-based scoring of the n-grams produced during the n-gram generation. Then, the intention type information from the classifier can be leveraged to refine the score. For example, by knowing the intention type of an utterance, a defined rule set for the subject utterance can be employed to identify and match common word patterns (at the level of parts of speech) for that intention type as a way to boost the scores of certain n-grams. Consider for example an utterance such as, “I need a bag.” This is an expression of a need (the intention type) and commonly, for such intention types, the word or phrase (more generally, the n-gram) immediately following the verb that expresses the intention type will be the topic of the intention. This is an example of a proximity rule for this intention type. Other rules for this intention type and rules for other intention types may be employed to score each possible intention topic n-gram and the n-gram with the highest score may be determined to be the best or most likely intention topic 308 for the utterance.

Returning to FIG. 2, the intention type and intention topic along with the original post are provided to a query formulation process 214. Here, a search is developed and made for possible creatives to return in response to the post. The search may be performed against a database of creatives, such as database 132, and the output will be a set of candidate creatives 216. In cases where action(s) other than the return of creatives is desired, a search may be made over databases including the relevant items appropriate for the deserted action(s). For example, where one desired action is transmission of an alert to one or more persons, the search may be made over one or more databases including profiles of individuals to be notified in the event specified intention types/topics are identified.

In parallel, the intention type, topic and original post are provided to an actionability classification procedure 218 to determine whether or not the intention topic is actionable. By actionable we mean an intention topic that is worthy of taking action, or for which it is permissible to do so (e.g., in the form of returning an advertisement, etc.). The actionability determination is then used to assist in scoring 220 the candidate creatives according to their relevance. The result(s) is (are) reported 222 as matches—i.e., the creative(s) (advertisement(s)) deemed most relevant to the original post, as measured by its (their) relevance to the intention topic of that post.

The present process of determining matching creatives for a subject post thus involves much more than merely determining sentiment (as is done in other processes). Understanding sentiment alone is typically an insufficient basis on which to take action (e.g., by responding with a creative). For example, sentiment may reveal information about a like or dislike of a person making a post, but it (alone) says nothing about that individual's needs, wants, check-ins (e.g., location-based intentions), etc. Stated differently, sentiment is not the same as actionable intention information.

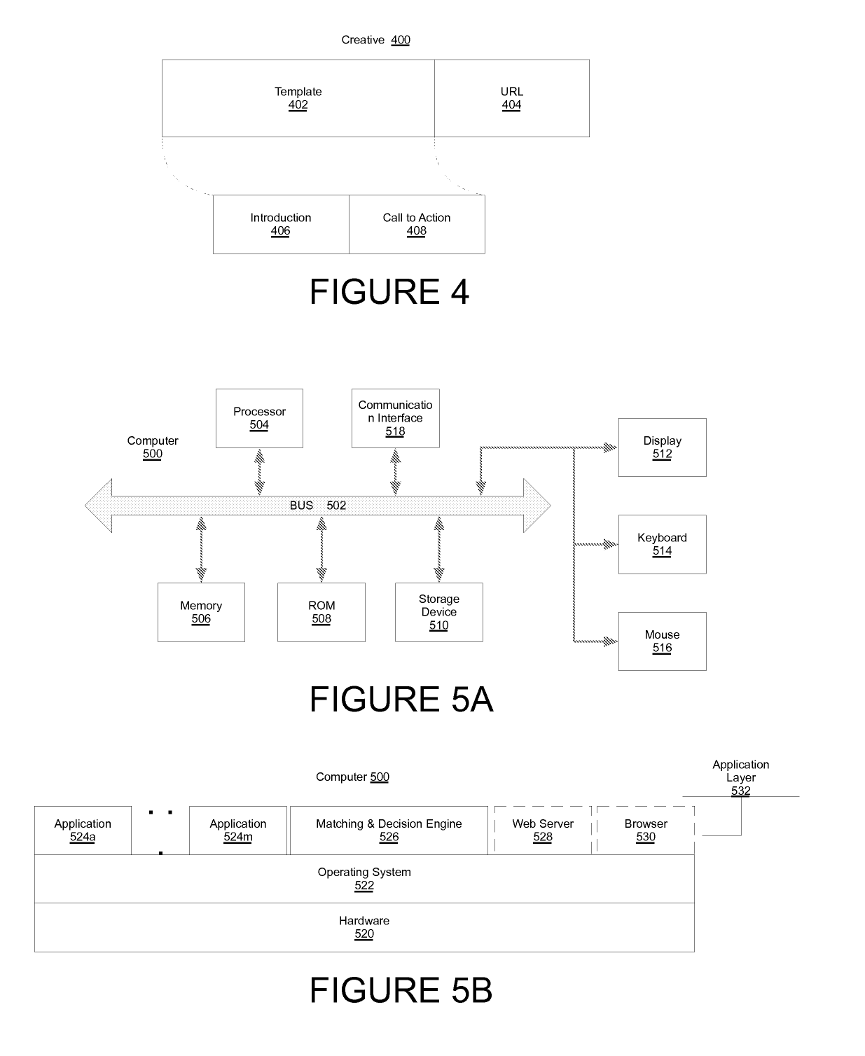

To ensure a high probability of success (e.g., success being measured by a recipient acting upon a creative returned in response to a post), creatives are not purely arbitrary sentences; they are designed to have a structure tailored to the context of the conversation in which they are to be inserted. As illustrated in FIG. 4, a creative 400 may be thought of as consisting of “slots”, including a slot 402 for a template and another slot 404 for a URL (or other direction aiding material) to the landing site/page. The templates 402 may be made up of an introduction 406, which is intended to identify the reason and source of message, e.g., “for more information about x, y, z, . . . ”, or “We at company x believe that you can get valuable sources of information at . . . ”; and a call to action 408, which invites the user to do something. The minimal form of such an invitation may be to click on a link (i.e., to select a link to the landing site by executing a mouse click while the screen cursor displayed on a client system is indicating the URL portion of the creative), but the call to action can go beyond this to some form of cognitive action like learn, study, understand, see, etc.

The entries or content for each slot of a creative may be derived from background knowledge or experience of an operator or administrator of an ad-insertion service that operates server 120 (e.g., an advertising professional who might have developed certain kinds of preferred introductions for different situations) as well as content gleaned automatically from the takeoff and landing sites or related domain content (e.g., Wikipedia™ content regarding a particular subject or content from similar conversations). Concepts (or themes) are sets of words that express some fundamental meaning of the domain, e.g., when discussing automobiles, the term “sports utility vehicle” has a certain connotation, and such concepts can be entities or properties of entities, such as “SSRI side effects”, or user intentions like “great value deal”. The introduction will tend to be the template component that contains references to such concepts, e.g., “for information about SSRI side effects, . . . ”, while the call to action will tend to reference the user cognitive action to be taken and a landing page address. Of course, template slots other than just introductions and calls to action may also be present in the templates and, if present, these too would be populated when creating the templates database. For example, a slot called “conversational reference”, which can contain references to content or properties of the conversation, may be employed. Or, some templates may have two possible calls to action, e.g., “do x OR do y”. The full set of creatives is, therefore, the set of all possible compositions of the elements from each of the slots.

In accordance with the present invention, the template and landing page databases 126, 128 may be populated on an on-going basis and used to formulate the creative(s). In the case of the templates database 126, this involves populating each of the introduction and call to action slots with candidates and storing the results. That is, server 120 (e.g., the matching and decision engine or a separate template creation engine (not shown in detail)) may automatically create all possible combinations of introductions and calls to action (the product of the two) and store these combinations in template database 126. For the landing page database, a crawl, an API call or other content gathering means may be employed to populate database 128. The full inventory of possible creatives may then be created by appending all possible landing page URLs from the landing page database to each template from the template database and storing the results in a creative database 132. Creatives may be created in advance and/or real time (or quasi-real time), for example in response to a trigger. Once the various databases have been populated (assuming they are used), the above-described matching process in order to determine candidate creatives to be presented to a user on a takeoff page may be employed.

By analyzing the contents of sites such as web pages, forums and other forms of social media then, systems configured in accordance with the present invention are able to determine actionable intentions of users of the sites and recommend or even take contextually relevant actions (such as, for example, inserting links and associated text at appropriate points in a conversation, directing users to other on-line material that may be helpful to them, alerting others to the existence and/or content of the conversation, updating or constructing user profiles, etc.). To maximize the relevance of these actions to users, these systems are preferably designed to detect and respond to important conversational indicators, such as particular intention types and topics expressed within an online posting. By matching the intention type and topics presented by an author against a set of potential actions, the present systems can select and take those actions most relevant to the authored post. For example, a query directive could be linked to content that provides either a direct answer to the question being asked, or to other material that may be helpful. In other instances, a number of links to content whose tenor, tone and meaning are determined to be relevant (and perhaps useful) in the context of the conversation may be presented.

In the discussion above we use the term “creative” to designate that portion of the content being inserted into the conversation which is intended for presentation to the conversation participants and/or others (i.e., intended to be viewed by them), but this should not be read as restricting the present invention solely to means for inserting commercial content. By creatives, we mean a broader construct, which may include some combination of links or other direction-aiding materials, text, audio and/or visual elements. Creatives may be portions of larger constructs, which we refer to as “payloads”. A payload may include content in addition to a creative, which other content is not itself intended for display to conversation participants or others, but which may be used to direct placement of the creative within a takeoff page, to gather statistics from the takeoff page, or provide for or perform another function. For example, a payload may include computer-readable instructions or computer-interpretable tags or other information. In some instances, a creative will be the sole constituent of a payload, but this is not necessarily so.

The location(s) at which the creatives are presented (which is, generally, also the location at which the conversation is taking place) is referred to as a “takeoff site”, and the location(s) to which users are directed when they click on one of the links (or follow the direction-aiding materials) is referred to as a “landing site”, but this should not be read as restricting the present invention solely to websites. In the context of takeoff and landing sites, the term site is intended to encompass, respectively, any environment where conversations may occur and any environment to which the conversation participants (or others reading the conversation) might be directed.

Takeoff sites include takeoff pages, at which individual conversations, or portions thereof, may be displayed, instantiated or presented. Landing sites include landing pages at which the content deemed to be of interest to the conversation participants (or others) may be hosted or otherwise made accessible. Thus, while a takeoff site is typically a social media site at which users are engaged in some sort of network-enabled social conversation with one or more other users, this need not necessarily be the case and the term may also encompass software applications in which conversations are hosted as well as IM threads, etc. Likewise, landing sites can consist of either other on-line conversations on social media sites (including, but not limited to, the same site as the takeoff site) or sites containing curated content (e.g., blogs), but may also be software applications, IM threads, etc. The aim is to enrich a user's social media experience and also enhance the value of curated content by providing users with natural entry points to that content from conversations that they are already viewing or engaging in.

If creatives are to be provided for display, the decision and matching engine passes the creatives (or links to same) to the subject takeoff site and/or other content destinations, where the creatives may be displayed near (i.e., in a contextually relevant location for) the original post. For example, the creatives may be displayed next in order in the conversation thread or may be displayed alongside the conversation thread so as not to be disruptive thereto. This may be accomplished through the use of instructions included with the creative in the payload, code injected into the takeoff page, or by code in a software application, which code or instructions direct the placement of the creatives from server 120. In other cases, the creatives may simply be displayed in the content destination or is a stream provided by the content destination.

The present invention thus determines for a given user interest, one or more contextually meaningful creatives and suitable landing page(s) whose contents are relevant for persons having those interests. If there is a sufficiently strong match, that creative and the URL of the landing page (or links to same) are provided for display in the content destination (e.g., in a contextually relevant location with respect to the takeoff message), thereby providing a recommendation to the people engaged in or monitoring the content destination.

The matching procedure described above provides a method for selecting relevant creatives based on textual data available from the takeoff page(s), templates and landing page(s). Similar processes can be employed for discovering the content created by content producers and indexing the sites where such content can be found.

Further, these processes may be enhanced to take into account other information, for example feedback available from usage logs that track user interaction with the creatives and/or content sites, such as mouseovers or clicks, and/or subsequent user actions, such as product purchases or page visits within a landing site. That is, an adaptive component which takes into account user behavior can be added to the above-described matching procedure by, for example, altering the score of a given landing page depending on the clickthrough response a creative has received in the past, user behavior at the landing site, or other user behavior of interest.

The foregoing discussion highlights the ability of the present system to provide system operators with strategies for content insertions. Recall also that in the construction of a creative there are a number of “slots” that can be filled. If we regard the “theme” as one such slot, then for a fixed theme, the content of the other creative slots can be permitted to vary and the set of results will be thematically invariant, but otherwise distinct creatives. Different ones of these creatives can then be used within one or more conversational contexts and the results monitored to determine which is the best set of creative content for the defined theme. Stated differently, the present infrastructure allows a determination of a solution to the question, which creative content is best for a given theme.

Other problem constructs may involve determining the best time to insert a creative. For example, analysis of the results of inserting creatives into content destinations may reveal information that allows service providers to choose optimum or near optimum times to insert future creatives so as to maximize the likelihood that URLs associated with those creatives will be selected by content consumers. The sum of the results from these kinds of learning instances (facilitated by the above-described infrastructure) gives rise to additional marketing strategies.

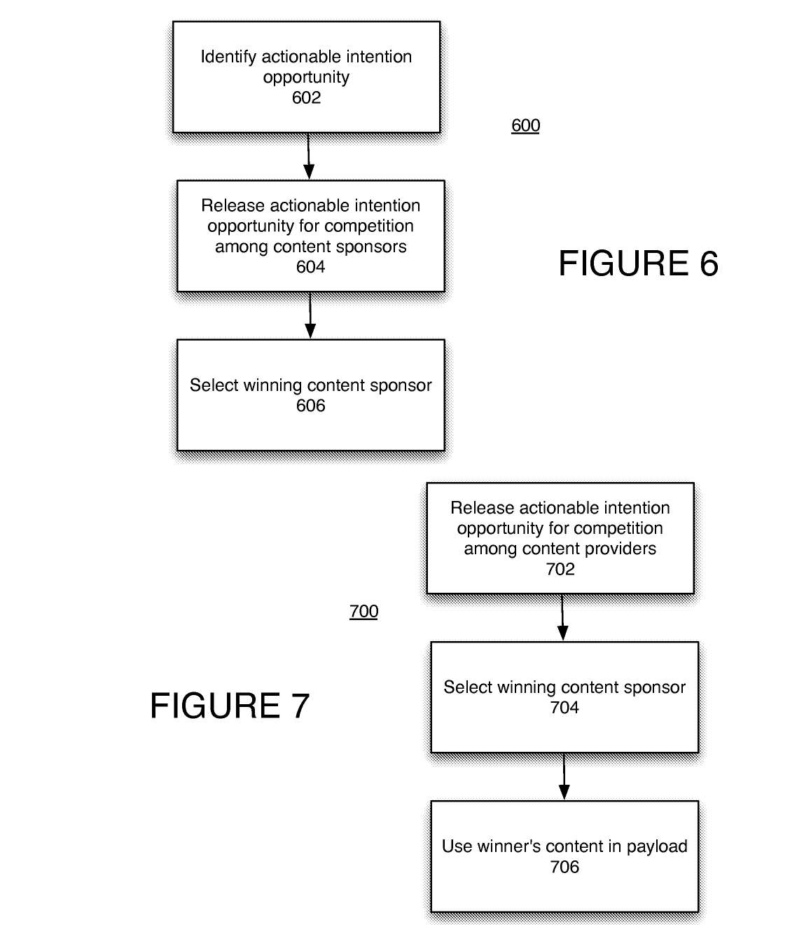

In some embodiments of the present invention content providers may compete with one another, e.g., in an auction or similar process, for the right to provide creative once an actionable intention of a user as expressed in an on-line conversation or similar environment has been identified. That is, and with reference to process 600 illustrated in FIG. 6, once the present system has determined an actionable intention 602 (for example, in accordance with the procedure described above with reference to FIG. 2), the existence of the opportunity for content insertion may be released for bidding by content sponsors 604. Such a release may be made automatically (e.g., in near real time) to an automated auction site where content sponsors lodge advance bids against defined content insertion opportunities in a fashion similar to that used for keyword bidding at search engines. In essence, the content sponsors may select from a variety of categorized content insertion opportunities (e.g., categorized by opportunity types, demographics, etc.) and lodge predetermined bids against those opportunities. Opportunities that fall within categories for which bids have been lodged may then be awarded to a content sponsor on the basis of a highest bid or on the basis of a bid and other factors. Such other factors may include measures of effectiveness of the bidding content sponsor in the past, where effectiveness may be assessed according to any of a varieties of categories, including but not limited to user feedback concerning the sponsored content that was inserted in previous conversations at the direction of the content sponsor in accordance with the present invention. The “winning” content sponsor is then awarded the content insertion opportunity 606.

In some instances the winning content sponsor may proceed with content insertion in the online conversation in the fashion discussed above. However, in other instances the content sponsor may release the opportunity for competition among content providers. That is, and with reference to process 700 illustrated in FIG. 7, the content sponsor may award the content insertion opportunity to a content sponsor selected according to a bidding process similar to that by which the content sponsor is selected.

As shown in the illustration, in one embodiment of the invention once the content sponsor for which the identified actionable intention opportunity has been selected, that content sponsor releases the opportunity for competition among content providers 702. Such a release may be made automatically (e.g., in near real time) to an automated auction site where content providers lodge advance bids against defined content insertion opportunities in a fashion similar to that used for the content sponsors. In essence, the content providers may select from a variety of categorized content insertion opportunities (e.g., categorized by opportunity types, demographics, etc.) and lodge predetermined bids against those opportunities. Opportunities that fall within categories for which bids have been lodged may then be awarded to a content provider on the basis of a highest bid or on the basis of a bid and other factors. Such other factors may include measures of effectiveness of the bidding content provider in the past, where effectiveness may be assessed according to any of a varieties of categories, including but not limited to user feedback concerning the content that was inserted in previous conversations in accordance with the present invention. The “winning” content provider is then awarded the content insertion opportunity 704 and that content provider's content is inserted into the online conversation 706, as described above.

The content providers may be afforded the opportunity to bid on sponsored content insertion opportunities in an open fashion or the opportunities may be limited (at the direction of a content sponsor) to only preselected content providers. Such preselection may include registration by the content provider in a network for such providers maintained by a content sponsor. Preselection may also include agreements on the part of the content providers to abide by restrictions on content specified by the content sponsor. In this way, content sponsors can maintain control over their brands and associations of those brands with content inserted into online conversations. Content of a content provider may be predesignated for inclusion in creative as discussed above and that content registered by the content providers at the time of placing the bids.

As is apparent from the foregoing discussion, aspects of the present invention involve the use of various computer systems and computer readable storage media having computer-readable instructions stored thereon. FIG. 5A provides an example of a computer system 500 that is representative of any of the servers or client systems discussed herein. Note, not all of the various computer systems may have all of the features of computer system 500. For example, certain of the servers discussed above may not include a display inasmuch as the display function may be provided by a client computer communicatively coupled to the server. Such details are not critical to the present invention. Computer systems such as computer system 500 may be referred to by other names, for example as hand-held devices, mobile devices, smart phones, multiprocessor systems, microprocessor-based electronic devices, digital signal processor-based devices, networked computer systems, minicomputers, mainframe computers, personal computers, servers, laptop computers, tablet computers, and the like. Such labels are not critical to the present invention.

Computer system 500 includes a bus 502 or other communication mechanism for communicating information, and a processor 504 coupled with the bus 502 for processing information. Computer system 500 also includes a main memory 506, such as a random access memory (RAM) or other dynamic storage device, coupled to the bus 502 for storing information and instructions to be executed by processor 504. Main memory 506 also may be used for storing temporary variables or other intermediate information during execution of instructions to be executed by processor 504. Computer system 500 further includes a read only memory (ROM) 408 or other static storage device coupled to the bus 502 for storing static information and instructions for the processor 504. A storage device 510, which may be one or more of a floppy disk, a flexible disk, a hard disk, flash memory-based storage medium, magnetic tape or other magnetic storage medium, a compact disk (CD)-ROM, a digital versatile disk (DVD)-ROM, or other optical storage medium, or any other storage medium from which processor 504 can read, is provided and coupled to the bus 502 for storing information and instructions (e.g., operating systems, applications programs and the like).

Computer system 500 may be coupled via the bus 502 to a display 512, such as a flat panel display, for displaying information to a computer user. An input device 514, such as a keyboard including alphanumeric and other keys, is coupled to the bus 502 for communicating information and command selections to the processor 504. Another type of user input device is cursor control device 516, such as a mouse, a trackball, or cursor direction keys for communicating direction information and command selections to processor 504 and for controlling cursor movement on the display 512. Other user interface devices, such as microphones, speakers, etc. are not shown in detail but may be involved with the receipt of user input and/or presentation of output.

The processes referred to herein may be implemented by processor 504 executing appropriate sequences of computer-readable instructions contained in main memory 506. Such instructions may be read into main memory 506 from another computer-readable medium, such as storage device 510, and execution of the sequences of instructions contained in the main memory 506 causes the processor 504 to perform the associated actions. In alternative embodiments, hard-wired circuitry or firmware-controlled processing units (e.g., field programmable gate arrays) may be used in place of or in combination with processor 504 and its associated computer software instructions to implement the invention. The computer-readable instructions may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, all of the aforementioned terms are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying” or the like, refer to the action and processes of an appropriately programmed computer system, such as computer system 500 or similar electronic computing device, that manipulates and transforms data represented as physical (electronic) quantities within its registers and memories into other data similarly represented as physical quantities within its memories or registers or other such information storage, transmission or display devices.

Computer system 500 also includes a communication interface 518 coupled to the bus 502. Communication interface 518 provides a two-way data communication channel with a computer network, such as network 130 in FIG. 1, which provides connectivity to and among the various servers discussed above. For example, communication interface 518 may be a local area network (LAN) card to provide a data communication connection to a compatible LAN, which itself is communicatively coupled to the Internet through one or more Internet service provider networks. The precise details of such communication paths are not critical to the present invention. What is important is that computer system 500 can send and receive messages and data through the communication interface 518 and in that way communication with hosts accessible via the Internet.

The various databases described herein are computer-based record keeping systems. Stated differently, these databases are each a combination of computer hardware and software that act together to allow for the storage and retrieval of information (data). Accordingly, they may resemble computer system 500, and are often characterized by having storage mediums capable of accommodating significant amounts of information.

FIG. 5B illustrates a computer system 500 from the point of view of its software architecture. Computer system 500 may be server 120 referred to above or, with appropriate applications comprising a software application layer 532, may be a client system or one of the host servers for a takeoff and/or landing site.

The various hardware components of computer system 500 are represented as a hardware layer 520. An operating system 522 abstracts the hardware layer and acts as a host for various applications 524a-524m, that run on computer system 500. In the case of server 120, the operating system acts as a host for a matching and decision engine 526, which is configured to perform the processes described above (e.g., to provide creative selections and insertions or other actions). For a server 102 and/or 108, the operating system may host a web server application 528, which provides access from the client computers via web browsers. Such a web server may also be hosted on server 120 to provide an interface by which the host servers 102 and 108 may communicate with server 120. In the case of a client system, the operating system acts as a host for a Web browser application 532, but not a matching and decision engine or (typically) a web server.

As alluded to above, network 130 may include the Internet and the various servers and client computers communicatively coupled thereto may include computer systems, such as computer system 500, that are made up of one or more processors, associated memory (typically volatile and non-volatile) and other storage devices and peripherals that allow for connection to the Internet or other networks. The precise hardware configuration of the hosting and client resources is generally not critical to the present invention, nor are the precise algorithms used to implement the services and methods described herein. Instead, the focus is on the nature of the services provided by the present invention.

Thus, methods and systems for recognizing intentions of a user as expressed in an on-line conversation or similar environment, and subsequently acting upon same, for example by bringing relevant or related content to the attention of the user and/or making others aware of the conversation, have been described. The present invention uses both intention type and topic to determine candidate creatives (and/or other actions) and evaluates those candidates according to an assessment of the actionability of the intention in order to determine which (if any) should be returned to the participants in the conversation. This process can also take into account various factors such as campaign management requirements (e.g., creative exposure limits) and conversational statistics to decide whether to place a creative or which creative to deliver. Further, determining which, if any, of the creatives to be displayed may include information about the devices on which the creative may be displayed. For example, screen size limit or text string length limit may be considered.

In various embodiments of the invention, the decision process may also incorporate learning based on past experiences with the creatives. For example, user interaction with previous instances of the creatives when inserted into takeoff pages may be tracked and used when deciding which, if any, creatives to provide for insertion. Moreover, such experience may be used in the matching process when deciding which introductions, calls to action and other components to combine with one another to form a creative. Likewise, past experience with creative placement within a takeoff page may be monitored and used to aid the decision about when to insert a creative in a takeoff page. Further, features or metrics regarding the conversation, such as conversational velocity, may be monitored and used as a guide for deciding whether and when to insert creatives. Such functions may be incorporated in the matching and decision engine, as appropriate.

Of course, the present invention is not limited to being used in conjunction with the insertion of creatives into on-line conversations. In various embodiments, the present systems and methods may be employed to alert others (e.g., those not currently engaged in the on-line conversation) to the existence and/or content of the conversation (e.g., as an enticement to join the conversation, to take action with respect to the conversation, to monitor or moderate the conversation, etc.). Further, intention type and topic as determined by the present methods and systems may be used to create, augment, inform or otherwise include or interact with one or more user profiles. Such profiles may be fashioned over a period of time in order to develop a more complete understanding of a particular user, which understanding may be used to determine which advertisements to present to the user and when to present them, etc.

In the foregoing discussion, the focus has been on creating links to guide users from conversational content to curated content, but in general the present methods and systems may be employed to create and insert links between any content of different modes. So, for example, the present methods and systems can be used to deliver curated content to sites hosting conversational content. In this regard, curated content can be regarded broadly as any content under editorial control of a site operator, or even profiles of individuals (e.g., Web-based biographies or profiles commonly associated with social networking sites or service provider sites). For example, links to such profiles may be used to suggest certain people (e.g., a subject matter expert) to join a conversation or answer a question, or even the reverse, e.g., suggest that a person join a particular conversation because he/she would provide information of value to that conversation. Thus, the referral process afforded by the present invention operates in a direction from conversation to curated (a takeoff page hosting conversational content to a landing page hosting curated content), or vice-versa. Indeed, one could use the present methods for mapping conversations to conversations, for example across on-line communities.

What is claimed is:

1. A method, comprising:
at a processor-based server that includes a non-transitory computer-readable storage medium storing computer-readable instructions, the processor executing said instructions to:
recognize, within an on-line conversation, actionable user intention with respect to a product or service;
provide, on the basis of the recognized actionable user intention, information concerning an opportunity for content insertion in the online conversation for competitive bidding by content sponsors;
provide, responsive to selection of a winning content sponsor, information concerning the opportunity for content insertion in the online conversation for competitive bidding by content providers; and
deliver, responsive to selection of a winning content provider, a payload into the online conversation, said payload associated with content provided by winning content provider.

2. The method of claim 1, wherein the payload is delivered into a content destination comprising a social networking site.

3. The method of claim 1, wherein the payload is in the form of a referral link to a web page.

4. The method of claim 1, wherein the processor further executes said instructions to track performance of the payload by recognizing actionable user intention with respect to a product or service referenced by the payload.
